(19) United States
(12) Patent Application Publication
(10) Pub. No.: US 2006/0047466 A1
(43) Pub. Date: Mar. 2, 2006

(54) System and method for monitoring rack equipment

(76) Inventor: Gene H. White, Double Oak, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/928,871

(22) Filed: Aug. 27, 2004

(51) Int. Cl. G01K 1/00

(52) U.S. Cl. 702/130

(57) ABSTRACT

A system and method for monitoring rack equipment. In one embodiment, first and second instances of computer equipment having first and second manufacturers, respectively, are deployed. Both instances of computer equipment are compliant in accordance with a common computer equipment environment specification. First and second sensors are associated with the first and second instances of computer equipment, respectively. A monitoring unit communicates with the first and second sensors in order to monitor environment conditions based upon the common computer equipment environment specification.

### BACKGROUND

Today's data centers include rows of racked-mounted computer equipment of various manufacturers that provide the massive computing necessary for supporting website hosting and other enterprises, often deployed in vast arrays of what are known as server farms. Information technology (IT) staff, such as system administrators, utilize a centralized management computer system that communicates with various sensors to monitor the data center at a room-level for environmental mishaps and power supply failures.

Room-level monitoring schemes, while detecting macro-level mishaps and failures, have proven insufficient at detecting and providing early warnings of cabinet-level issues. Manufacturer specific-sensors have been implemented ad hoc at the cabinet-level to augment the capabilities of the existing data centers. The manufacturer specific-sensors have been found, however, to encumber operations by increasing the number of form factors and protocols used in the data center. Accordingly, despite the capabilities of the existing room-level and ad hoc monitoring schemes, further improvements are warranted for monitoring environmental conditions in data centers.

### SUMMARY

A system and method are disclosed that provide for monitoring rack equipment. In one embodiment, first and second instances of computer equipment having first and second manufacturers, respectively, are deployed. Both instances of computer equipment are compliant in accordance with a common computer equipment environment specification. First and second sensors are associated with the first and second instances of computer equipment, respectively. A monitoring unit communicates with the first and second sensors in order to monitor environment conditions based upon the common computer equipment environment specification.

### BRIEF DESCRIPTION OF THE DRAWINGS

FIG. 1 depicts a perspective view of a data center wherein a monitoring system according to one embodiment may be deployed;

FIG. 2 depicts a front plan view of one embodiment of an equipment rack utilized in the data center of FIG. 1;

FIG. 3 depicts a schematic representation of one embodiment of a monitoring system; and

FIG. 4 depicts a flow chart of one embodiment of a method for monitoring rack equipment.

### DETAILED DESCRIPTION OF THE DRAWINGS

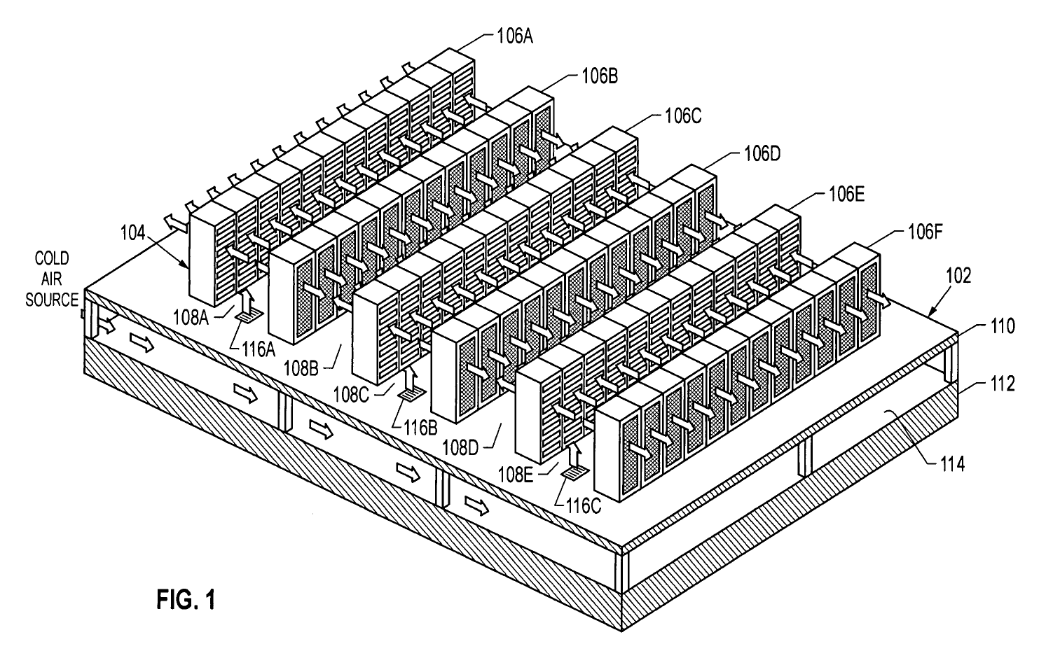

In the drawings, like or similar elements are designated with identical reference numerals throughout the several views thereof, and the various elements depicted are not necessarily drawn to scale. Referring now to FIG. 1, therein is depicted a data center 102 where a monitoring system according to one embodiment may be deployed. The data center 102 includes equipment cabinets or racks, which are depicted generally as equipment racks 104, arranged in rows 106A-106F such that aisles 108A-108E are defined therebetween. The data center 102 may be any type of data processing environment such as a server farm, an American Society of Heating, Refrigerating and Air-conditioning Engineers (ASHRAE) class 1 environment, or ASHRAE class 2 environment. An ASHRAE class 1 environment is a data processing environment with tightly controlled environmental parameters and mission critical operations that utilizes enterprise servers and high-end storage products. An ASHRAE class 2 environment is typically an information technology space, office environment, or laboratory environment with some control of environmental parameters. This type of data center usually employs small servers, storage products, personal computers, and workstations, for example. In the illustrated embodiment, an ASHRAE class 1 environment is depicted by way of example and not by way of limitation.

A raised floor 110, which supports equipment racks 104, is supported above sub-floor 112 in order to provide for a passageway 114 therebetween. Aisles 108A, 108C, and 108E include vents, such as vent 116A in aisle 108A, vent 116B in aisle 108C, and vent 116C in aisle 108E, that provide for the transport of cooling air from passageway 114 to the aisles 108A, 108C, and 108E. Hence, aisles 108A, 108C, and 108A, are cold aisles and aisles 108B, 108D, and 108F, which have no vents, are hot aisles.

During operation, each instance of computer equipment within an equipment rack 104 may radiate over 500 Watts of heat. This may result in excess of 10,000 Watts of heat per equipment rack 104. In order to cool the computer equipment, a plenum of cooling air originating at a cold air source is pulled through passageway 114 and discharged up through the vents traveling the path depicted by the air flow arrows. More particularly, in the illustrated embodiment, equipment racks 104 are arranged in a hot aisle/cold aisle configuration that optimizes cooling by separating the source of the cooling air from the discharge of the hot air. In the cold aisles, aisles 108A, 108C, and 108E, the equipment racks 104 are arranged front panel to front panel. On the other hand, in the hot aisles, aisles 108B, 108D, and 108F, the equipment racks 104 are arranged rear panel to rear panel. In this configuration, the cooling air that is discharged up through the vents is pulled through the front panels of the equipment racks 104 onto the faces of the computer equipment. This air is then exhausted out the rear panels of the computer racks 104 into the hot aisles 108B, 108D, and 108F where the air may be removed from the data center 102 through exhaust vents positioned in the ceiling.

It should be appreciated that despite the plenum of cooling air, the temperature in particular instances of computer equipment or entire equipment racks can exceed predetermined thresholds, thereby leading to overheating. Further, other parameters, such as humidity, input voltage, smoke, mechanical vibration, and intrusion, for example, may exceed predetermined thresholds and negatively impact data center operations.

As previously alluded to, the data center 102 includes computer equipment of various and possibly different manufacturers. Implementing the teachings presented herein, the computer equipment, regardless of manufacturer, is compliant in accordance with a common computer equipment environment specification that includes, for example, a thermal specification. In particular, by providing a common specification or standard across manufacturers, equipment rack-level and computer equipment-level monitoring may be efficiently accomplished by associating senors with the computer equipment to monitor aforementioned parameters such as, e.g., temperature. Depending on the number of computer racks, the amount of computer equipment, and the number of sensors utilized in the data center 102, an appropriate number of monitoring units are provided to communicate with the sensors in order to monitor environment conditions based upon the common computer equipment environment specification.

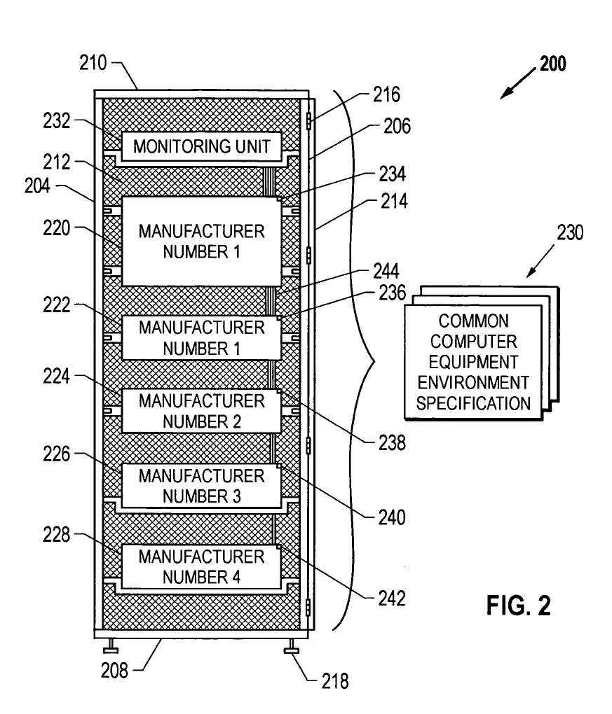

FIG. 2 depicts one embodiment of an equipment rack 200 utilized in the data center of FIG. 1. An extruded aluminum frame provides support for side panels 204 and 206, bottom panel 208, top panel 210, and rear panel door 212. The top panel 210 and rear panel door 212 may be perforated to provide for exhaust ventilation. For applications that require additional exhaust ventilation, the equipment rack 200 may be equipped with an extractor fan. A front panel door 214, which may also be perforated, is pivotally attached to the side panel 206 by hinges 216 and depicted in an open position.

In the illustrated embodiment, the equipment rack 200 is an enterprise-class rack system or Type A cabinet that conforms to the Electronic Industries Association (EIA) standard 310-D and provides 33 U (each U equals 1.75 in (44.45 mm)) of vertical mounting space which is extendible by 8 U with the use of an extension kit. It should be appreciated, however, that equipment racks that conform to other standards are available in a variety of sizes including 25 U and 41 U, for example. Four instances of computer equipment 220-228 are mounted within the equipment rack 200. Computer equipment 220 and 222 have a first manufacturer as indicated by the manufacturer number 1 designation on the equipment. Similarly, computer equipment 224 has a second manufacturer, computer equipment 226 has a third manufacturer, and computer equipment 228 has a fourth manufacturer. The computer equipment 220-228 may include high performance computing (HPC) equipment, class 1 server equipment, control room equipment, enterprise servers, database servers, multi-processor servers (i.e., two or more processors organized or partitioned according to any architecture), x86 rack servers, uninterruptible power system (UPS) products, storage products such as high capacity hard disk drives, and configurable computer equipment including blade equipment, for example. It should be further understood that the computer equipment 220-228 may use, where needed, any operating system (OS) including HP-UX®, Windows®-based OSs, Linux, and Unix, for example.

As illustrated in FIG. 2, the instances of computer equipment 220-228 are compliant in accordance with a common computer equipment environment specification 230 that provides guidelines for the design and construction of data centers and computer equipment. The common computer equipment environment specification 230 may include thermal, humidity, input voltage, smoke, mechanical vibration, and intrusion guidelines, for example. By way of example, exemplary thermal specifications for ASHRAE Class 1 and 2 data centers are presented in Tables 1 and 2, respectively.

TABLE 1
Thermal Specification for ASHRAE Class 1 Data Center

| | | Rate of |
|---|---|---|
| Temperature - | Temperature - | Temperature |
| Allowable | Recommended | Change - Maximum |
| 15° C. to 32° C. | 20° C. to 25° C. | 5° C./hour |

TABLE 2
Thermal Specification for ASHRAE Class 2 Data Center

| | | Rate of |
|---|---|---|
| Temperature - | Temperature - | Temperature |
| Allowable | Recommended | Change - Maximum |
| 10° C. to 35° C. | 20° C. to 25° C. | 5° C./hour |

By way of another example, exemplary humidity specifications for ASHRAE Class 1 and 2 data centers are presented in Tables 3 and 4, respectively.

TABLE 3
Humidity Specification for ASHRAE Class 1 Data
Center

| Relative-Humidity | Relative-Humidity | Dew |
|---|---|---|
| (Noncondensing) - | (Noncondensing) - | Point - |
| Allowable | Recommended | Maximum |
| 20% to 80% | 40% to 55% | 17 |

TABLE 4
Humidity Specification for ASHRAE Class 2 Data
Center

| Relative-Humidity | Relative-Humidity | Dew |
|---|---|---|
| (Noncondensing) - | (Noncondensing) - | Point - |
| Allowable | Recommended | Maximum |
| 20% to 80% | 40% to 55% | 21 |

A monitoring unit 232 is mounted in equipment rack 200 to monitor environment conditions based upon the common computer equipment environment specification 230. Sensors 234-242 are associated with computer equipment 220-228, respectively, and in communication with the monitoring unit 232 by way of cabling 244. It should be appreciated that the sensors may be OEM equipment that is integrated with the computer equipment or after market sensors that utilize off the shelf components, for example. In one implementation, the sensors 234-242 may be interfaced with data acquisition Peripheral Component Interconnect (PCI) cards.

As previously alluded to, each sensor measures one or more ambient conditions. In one embodiment, one temperature sensor may be placed in the front of the equipment rack to measure the input air temperature and another sensor may be placed in the rear of the equipment rack near the computer equipment's exhaust or other temperature-sensitive component. Monitoring the temperature difference allows the system to determine if excessive heat is being generated by the computer equipment or the input air temperature is becoming too warm for proper equipment operation.

A humidity sensor may be employed to monitor humidity levels within the equipment rack or at a particular piece of computer equipment. Typically, humidity sensors are positioned towards the front of the rack. An input voltage sensor may be utilized to monitor any 100 to 240 VAC voltage line within the equipment rack. An optical smoke sensor detects smoke (particulate matter) passing by the sampling tube and uses an intake fan to draw the smoke from the sampling tube into the smoke sensor. Typically, the sampling tube is positioned in the path of the exhaust air from the servers. An intrusion sensor, which may be as simple as a reed switch having open and closed positions, can send an alert to the central monitoring unit to identify an open door. Mechanical shock and vibration sensors alert system administrators when a rack has been bumped or struck whether as a result of a natural disaster, such as an earthquake, or an intruder attempting a forceable entry. Regardless of the sensor or the array of sensors selected, the sensors utilized in the equipment rack to monitor the ambient conditions associated with the computer rack and computer equipment forward data to the monitoring unit 232 which provides an interface for an administrator to perform rack-level and equipment-level management.

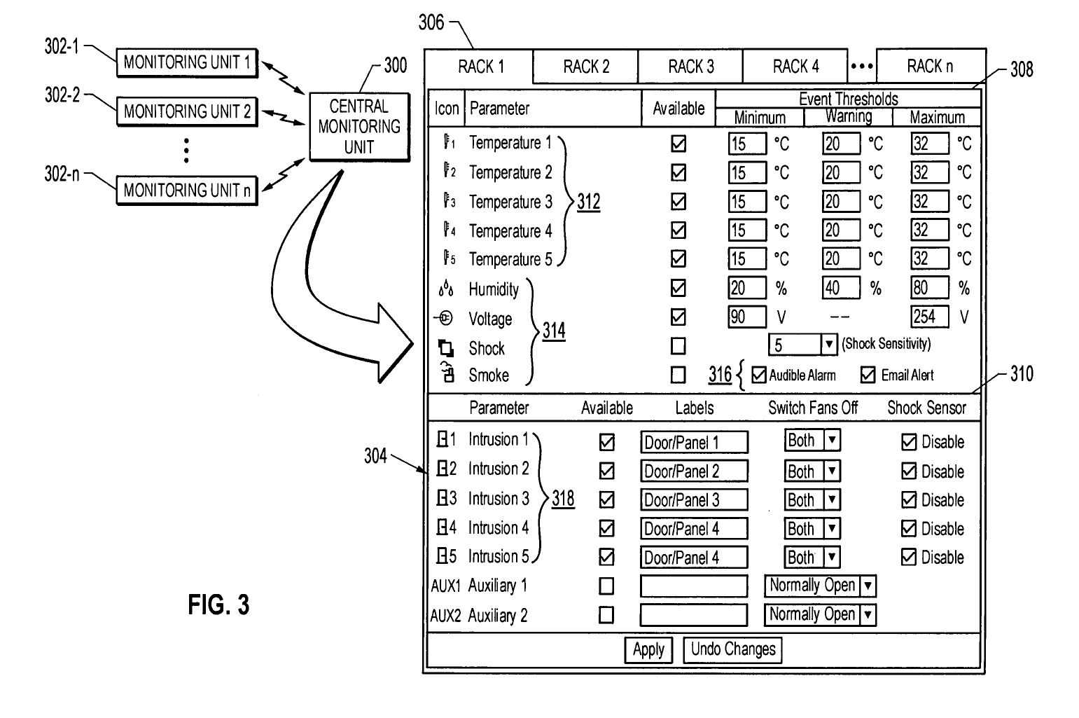

FIG. 3 depicts one embodiment of a monitoring system including a central monitoring unit 300 that is operable to manage a data center such as the data center 102 presented in FIG. 1. Monitoring units 302-1, 302-2, 302-n are in communication with the central monitoring unit 300 via a cable connection or wireless connection, for example. In one implementation, each of the monitoring units 302-1 through 302-n is associated with an equipment rack 104 of FIG. 1. The central monitoring unit 300 may be associated with one of the equipment racks 104 of FIG. 1 or a network operations center (NOC), for example.

Central monitoring unit 300 provides a management console 304 in the form of a graphical user interface (GUI) or command line interface that enables an administrator to monitor the environmental and security parameters such as temperature, humidity, input voltage, smoke, mechanical vibration, and intrusion. Further, the management console 304 allows an administrator to set appropriate, automatic responses to changes in the status of computer equipment and computer racks as monitored by those sensors.

Tabs 306 enable the administrator to effectively monitor and manage the computer equipment of n equipment racks. As illustrated, the rack 1 tab is selected and panes 308 and 310 provide for the configuration of the sensor alerts and management of the rack on an equipment-level basis. In pane 308, temperature panel 312 provides for the management of the temperature of five instances of computer equipment with temperature indicators 1-5. Panel 314 provides for the monitoring and management of humidity, voltage, shock, and smoke at the equipment rack-level. Panel 316 provides for the issuance of alerts if the event thresholds of panels 312 and 314 reach the warning levels. The administrator may be alerted by an audible alarm, email alert, pager alert, SNMP trap, or broadcast message, for example. As illustrated, the audible alarm and email alert options are checked to provide a notification to an administrator in response to a temperature warning event threshold. Pane 310 includes panel 318 for enabling monitoring of the security of one or more instances of computer equipment in rack 1. Although a particular interface 304 has been presented, it should be appreciated that the management interface associated with system and method for monitoring rack equipment presented herein may be of any configuration that meets the requirements of a data center in accordance with the common computer equipment environment specification regardless of the type of equipment or manufacturer.

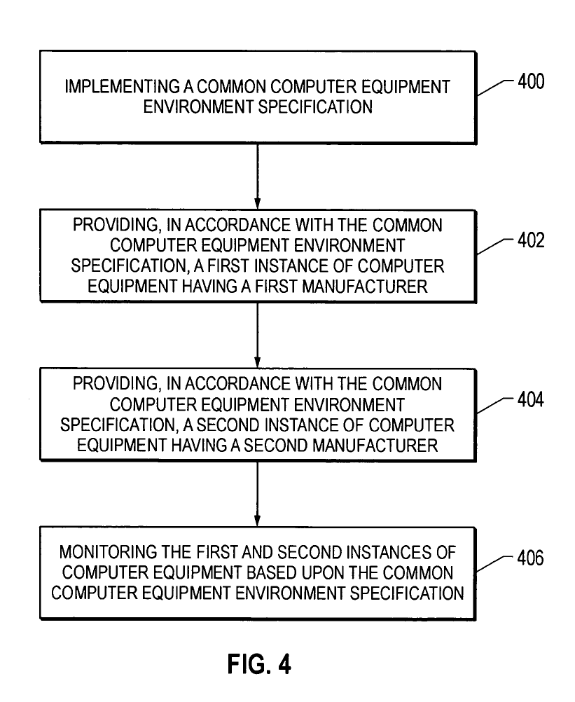

FIG. 4 depicts one embodiment of a method for monitoring rack equipment, e.g., equipment deployed at a data center. At block 400, a common computer equipment environment specification is implemented. At block 402, in accordance with the common computer equipment environment specification, a first instance of computer having a first manufacturer is provided. At block 404, in accordance with the common computer equipment environment specification, a second instance of computer having a second manufacturer is provided. The first and second instances of the computer equipment may be disposed in the same equipment rack or in different equipment racks. At block 406, the first and second instances of computer equipment are monitored based upon the common computer equipment environment specification.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A system for monitoring rack equipment, comprising:
a first sensor associated with a first instance of computer equipment having a first manufacturer;
a second sensor associated with a second instance of computer equipment having a second manufacturer, said first and second instances of computer equipment being compliant in accordance with a common computer equipment environment specification; and
a monitoring unit in communication with said first and second sensors to monitor environment conditions based upon said common computer equipment environment specification.

2. The system as recited in claim 1, wherein said first and second instances of computer equipment comprise equipment selected from the group consisting of high performance computing (HPC) equipment, class 1 server equipment, control room equipment, enterprise servers, database servers, multi-processor servers, x86 rack servers, uninterruptible power system (UPS) products, storage products, and blade equipment.

3. The system as recited in claim 1, wherein said first and second instances of computer equipment are mounted in a computer rack.

4. The system as recited in claim 1, wherein said first and second instances of computer equipment are mounted in first and second computer racks, respectively.

5. The system as recited in claim 1, wherein said sensors measure temperature.

6. The system as recited in claim 1, wherein said sensors monitors a parameter selected from the group consisting of humidity, input voltage, smoke, mechanical vibration, and intrusion.

7. The system as recited in claim 1, wherein said monitoring unit is operable to provide a notification to an administrator in response to a predetermined thermal environment condition.

8. The system as recited in claim 1, wherein said common computer equipment environment specification includes a thermal specification requiring a temperature in the range of approximately 15° C. to approximately 32° C.

9. The system as recited in claim 1, wherein said common computer equipment environmental specification includes a thermal specification requiring a temperature in the range of approximately 20° C. to approximately 25° C.

10. A method for monitoring rack equipment, comprising:
implementing a common computer equipment environment specification;
providing, in accordance with said common computer equipment environment specification, a first instance of computer equipment having a first manufacturer;
providing, in accordance with said common computer equipment environment specification, a second instance of computer equipment having a second manufacturer; and
monitoring said first and second instances of computer equipment based upon said common computer equipment environment specification.

11. The method as recited in claim 10, wherein said common computer equipment environment specification comprises specifying an operational temperature range between approximately 15° C. and approximately 32° C.

12. The method as recited in claim 10, wherein said common computer equipment environment specification comprises specifying an operational temperature range between approximately 20° C. and approximately 25° C.

13. The method as recited in claim 10, wherein said first and second instances of computer equipment comprise equipment selected from the group consisting of high performance computing (HPC) equipment, class 1 server equipment, control room equipment, enterprise servers, database servers, multi-processor servers, x86 rack servers, uninterruptible power system (UPS) products, storage products, and blade equipment.

14. The method as recited in claim 10, further comprising mounting said first and second instances of computer equipment in a computer rack.

15. The method as recited in claim 10, further comprising mounting said first and second instances of computer equipment in first and second computer racks, respectively.

16. The method as recited in claim 10, wherein the operation of monitoring said first and second instances of computer equipment comprises measuring temperature.

17. The method as recited in claim 10, wherein the operation of monitoring said first and second instances of computer equipment comprises monitoring a parameter selected from the group consisting of humidity, input voltage, smoke, mechanical vibration, and intrusion.

18. The method as recited in claim 10, further comprising providing a notification to an administrator in response to a predetermined environment condition.

19. A system for monitoring rack equipment, comprising:
means for monitoring a first instance of computer equipment having a first manufacturer;
means for monitoring a second instance of computer equipment having a second manufacturer, said first and second instances of computer equipment being compliant in accordance with a common computer equipment environment specification; and
means for administrating, based upon said common computer equipment environment specification, said means for monitoring said first and second instances of computer equipment.

20. The system as recited in claim 19, wherein said first and second instances of computer equipment comprise equipment selected from the group consisting of high performance computing (HPC) equipment, class 1 server equipment, control room equipment, enterprise servers, database servers, multi-processor servers, x86 rack servers, uninterruptible power system (UPS) products, storage products, and blade equipment.

21. The system as recited in claim 19, wherein said means for monitoring said first and second instances of computer equipment comprise temperature sensors.

22. The system as recited in claim 19, wherein said common computer equipment environment specification includes a thermal specification requiring a temperature in the range of approximately 15° C. to approximately 32° C.

23. The system as recited in claim 19, wherein said common computer equipment environment specification includes a thermal specification requiring a temperature in the range of approximately 20° C. to approximately 25° C.
